(19) United States
(12) Patent Application Publication
(10) Pub. No.: US 2021/0237255 A1
(43) Pub. Date: Aug. 5, 2021

(54) TILER CADDY

(71) Applicant: Shark Toolers, a dba of Stathis & Liebesfeld, LLC, Morris Plains, NJ (US)

(72) Inventor: James Stathis, Morris Plains, NJ (US)

(21) Appl. No.: 17/126,096

(22) Filed: Dec. 18, 2020

Related U.S. Application Data
(63) Continuation-in-part of application No. 16/778,210, filed on Jan. 31, 2020, now abandoned.

(51) Int. Cl. B25H 1/12; B25H 1/04; B25H 1/08; B25H 3/02

(52) U.S. Cl. CPC B25H 1/12; B25H 1/04; B25H 3/04; B25H 3/022; B25H 1/08

(57) ABSTRACT

A simple, versatile tool and accessory caddy, temporarily attachable to a wall, rollable across a floor and securely providing easy access to a tile installer of all needed tile installation tools and accessories.

### FIELD OF THE INVENTION

This is a Continuation-in-Part Application claiming priority back to application Ser. No. 16/778,210 filed on Jan. 31, 2020.

A simple, versatile tool and accessory caddy, temporarily attachable to a wall, rollable across a floor, and securely providing easy access to a tile installer of all needed tile installation tools and accessories.

### BACKGROUND

The beauty of a tiled floor, tiled shower enclosure, or tiled wall, starts with quality materials and finishes with tight, even, grout joints where lippage—the variation in height of adjoining or neighboring tiles—is minimized or eliminated. A recent trend is the desirability of very large tiles, especially over large surfaces, such as floors or large expansive walls. These larger tiles make it harder to eliminate lippage without the use of a leveling system.

One such leveling system is sold under the brand Vortex®, which requires tilers to install leveling fasteners every ten inches or so across a tiling grid, in all directions. Other brands include, Perfect Level Master™ ‘T-Lock’, Raimondi RLS™ tile leveling system, Yaekoo™ wedges, and others. Whatever system is used, one of these or some other, invariably, what is universally required is ready access to the various parts, typically, including, clips that get placed under adjoining tiles as the tiles get laid in place, some type of wedge or T or leveler to be used in conjunction with the clips, as well as common tiling tools, including but not limited to spacers, a rubber mallet, a mastic knife, and the like.

The same issues present themselves when tiling an expansive wall, a backsplash, a tub surround, and anywhere it would be convenient to have essentially a toolkit at the ready. However, typical tool chests, tool organizers, or workbenches, even modified smaller versions, are cumbersome to have in the area where active tiling is occurring. Moreover, it must be continually moved as the work progresses.

Tilers also work on all of the aforementioned types of tile installations. For example, a tiler may be working on a floor one week, a tub/shower surround in the next week, and a large wall the following week. It would be beneficial to have one tool organizer capable of adapting to all situations—walls, floors, smaller spaces, etc.

There have been attempts to solve the difficulties noted. For example, in U.S. Pat. No. 4,819,800, titled TOOL STORAGE SYSTEM, disclosed is, “a tool box is formed of two identical shallow halves hinged together to have an open position for use and a closed position for carrying. A set of supports permit the box to be temporarily attached to a wall, such as the rear cab wall of a pickup truck or the like, in the open position providing access to tools held in a plurality of tool holders attached to planar walls of the box halves. The supports include resilient portions for quick release of the box halves. Handles on the tool box permit carrying in the closed position.” The temporary attachment of the tool chest here is via relatively permanent hooks. This does not work to solve the issues described.

In another example, U.S. Pat. No. 9,010,550 B2 titled UNDER-HOOD TOOL BAR, discloses, “a tool bar for securing under a hood of a car during repair and maintenance is disclosed. A rigid member spanning a substantial portion of the hood is flexibly secured to hooks. The hooks engage edges of the hood and may include a compliant covering. The hooks may secure to the rigid member by means of straps and the straps may be tensioned by means of tensioners secured to one of the hooks and the rigid member. A stabilizer secures to the rigid member and has an end that may be clipped or otherwise fastened to a portion of the hood to resist rotation of the rigid member. One or more tool retaining members secured to the rigid member, such as a socket rack, magnetic bar, hook groove, or the like.” Again, recognized is the need to have tools close and organized, but the solution requires a permanency of attachment points.

In another example, International Patent Application Ser. No. PCT/US2017/048654, titled ADHESIVE MOUNTING DEVICES, discloses, “adhesive mounting assemblies that are capable of attaching or adhering to a surface and that can be removed from the surface without causing damage to the surface. In some embodiments, the mounting assemblies are peeled off the surface. The present disclosure generally relates to adhesive articles including a mounting device. The adhesive articles have one or more adhesive areas (which can be part of one continuous adhesive area) exhibiting adhesive properties and one or more non-adhesive areas that lack significant adhesive properties. At least one of the non-adhesive areas is located in an area and/or has a size, shape, and/or geometry that lowers and/or controls at least one of the average peel force and/or the peak peel force of the adhesive article such that the peel force of the adhesive article does not exceed the threshold for causing damage to the surface from which the adhesive article is peeled. In some embodiments, at least one non-adhesive area is adjacent to or aligned with the mounting device on either the same major surface of a backing or on the opposing surface of the backing.” Here, separate adhesive hooks would have to be mounted prior to hanging a tool caddy on those hooks and repeated each time the tool caddy was to be moved.

In another example, U.S Pat. No. 9,943,956 titled, CANVAS TOOL CADDY, discloses, “a canvas tool caddy designed to removably fit over the handle of a rolling tool chest with telescopic handle. The canvas tool caddy is meant to supplement the tool storage of the rolling tool chest. The canvas caddy is removable from the rolling tool chest telescopic handle. The tool caddy optionally has one or more flexible, bendable spines, to bend the flat tool supporting base wall surface substrate into an open planar flat display configuration which retains its shape while supported on the handle of the rolling tool chest. The rolling tool chest's telescopic handles provide upward load forces counteracting downward load forces of the handle, and the equilibrium is spread equally along an internal horizontal spine, to keep the tool caddy open when opened from a close transport state to an open viewable, tool accessible state.”

In another example, U.S. Pat. No. 8,448,959 titled, TOOLBOX AND TOOL MOUNT FOR AERIAL WORK PLATFORM, discloses, “A toolbox is configured to hang from an upper rail of a guard rail of an aerial work platform, such as a scissor lift or cherry picker. A rail hanger is attached to a chest to removably hook the chest to the upper rail of the guard rail and removably suspend the chest from the upper rail and above the floor of the platform. A pull handle is attached to a top of the rail hanger. A pair of wheels is coupled to a bottom and the back of the chest. The toolbox has a height extending a majority of a height of the guard rail with the pair of wheels suspended above a floor of the platform when the chest is suspended from the upper rail. The toolbox can include a wire dispenser.”

In another example, U.S. Pat. No. 6,095,465 titled STRUCTURE FOR AND METHOD OF MOUNTING AN OBJECT ON A VERTICAL SURFACE AND A LAMINATED BACKING FOR SUCH A STRUCTURE, discloses, “A picture hanger is initially held in place on a wall in a temporary manner without damaging the wall by including a backing with a shock absorbing layer overlaid by a temporary adhesive film. Prior to the picture hanger being temporarily fastened to the wall, the temporary adhesive film is covered by a protective paper sheet. The shock absorbing layer prevents the wall from being indented when the hanger is permanently secured to the wall by hammering a pin or nail through the layer and film. The layer is sufficiently soft to hold the nail in place when the nail impales the layer prior to hammering the nail into the wall. Prior to the backing being secured to the hanger, the permanent adhesive film is overlaid by another removable protective sheet. Initially the backings are located on an elongated strip and are punched from the strip for mounting on the hook body.”

None of the foregoing references, alone or in combination, teach the salient and proprietary features or construction of the present disclosure, and as such, fail to be useful as a single tiler's tool caddy, rollable across a floor and temporarily attachable and moveable along a wall, to follow in front of a tiler's progress keeping all necessary and desirable tools and accessories at the ready.

The present disclosure teaches several embodiments that provide a portable, lightweight, utility storage device, capable of organizing and storing for immediate use, hand tools, tile spacers, cellphone, keys, pencil, markers, utility knife, rubber mallet, and the like, wherein the entire storage device is capable of rolling across a floor or mounting temporarily to drywall, cement board or Hardiebacker®, moveable with ease irrespective of the surface along which it is moveable, and supported in various orientations quickly and easily.

### SUMMARY

The present disclosure teaches a device with embodiments that provide a plurality of shelves and/or bins, mounted on wheels, configured to be immoveable and stationary when desired, and easily moveable to a next area when desired, whether that is across a floor or mounted to a wall, i.e., configured with both wheels for rolling and a proprietary configuration of nail-like fasteners to easily mount to a wall, again configured to be immoveable and stationary when desired, and easily moveable to a next area when desired.

In one embodiment, the plurality of shelves and/or bins are constructed from lightweight but sturdy plastic, so as to be light but durable and easily portable when loaded with supplies.

In one embodiment, the entire device is configured to be assembled, disassembled and reassembled when desired.

In one embodiment, the device can be configured with anti-tip braces to prevent spill-overs.

In one embodiment, the device may have any number of shelves and or compartments and/or bins incorporated into the design for any number of tools and/or supplies.

In one embodiment, the edges or outer sidewalls of the device may also be configured to hold tools, supplies, or other implements, such as a cellphone, and may be configured with pouches, hooks, magnets, hook and loop type materials, or other known means for attaching items.

In one embodiment, the edges of the device may be configured with a laser level to assist a tiler in keeping a straight and level line across a certain tile grid configuration.

In one embodiment, the back wall of the device is configured with a plurality of nail-like fasteners, that are configured in a proprietary arrangement to allow the user to orient the device on a wall however they want. In a preferred embodiment, two such nail-like fasteners are oriented in a general downward general direction at or near the top of the device, and then one or more such nail-like fasteners are oriented in a slightly downward direction but may angle straight downward, left and/or right, such that, when placed against a wall, will hold the device in whatever clockwise rotational orientation the user desires. In one embodiment, there could be just one such nail-like fastener, that is moveable to the user to be in whatever orientation is desired, to prevent rotation of the device. In this embodiment, the user would essentially hang the device using the top two nail-like fasteners at the desired location, and then move and orient the bottom fastener in an orientation to secure the device from any rotational movement and insert. The nail-like fasteners in this embodiment are fastened through the back wall of the device, but are slightly moveable within their bracket to adjust their angle into the wall and can then be pushed through at the desired angle.

In an alternative embodiment, the nail-like fasteners can have a screw function, having threads and be rotatable in their bracket to essentially screw them into the wall at the appropriate point. In a preferred embodiment, the threads are fairly wide to accomplish a quarter turn securing function. In other embodiments, the nail-like fasteners could have any number of threads to adjust the securing function with any number of turns required.

As described above, the nail-like fasteners allow the device to be temporarily but securely attached to a wall that is being worked on, made of drywall or other subsurface that is to be covered. The nail-like fasteners will grip the wall, penetrating it no more than ½ to support the entire device on the wall in a desired unfinished area, and making it easily liftable and moveable to a next area when desired. In one embodiment, the nail-like fasteners are sharp and stable in the back wall of the device to be supportive and capable of easily penetrating drywall, cementboard, and most surfaces for tiling. In one embodiment, the nail-like fasteners penetrate to a maximum of ½ outside the back surface of the back wall of the device, and therefore will not disturb any plumbing, electric or other structural system behind the wall. On the opposite inner side, the nail-like fasteners have a corresponding nail head to facilitate pushing the fastener into the wall surface where necessary. Because the nail-like fasteners generally orient downwards, the device will ‘sit down’ onto and into the wall wherever the user places it. Because the nail-like fasteners do not each orient in exactly the same direction as their corresponding counterparts, the device may be mounted slightly tilted in any direction, left or right, and still have one fastener orienting generally downward to temporarily provide the support necessary for stability, and yet allow the user to orient the device in a position most convenient to them in a given situation. As noted above, in one embodiment, the nail-like fasteners could also have a screw function to assist the user in inserting the nail-like fasteners into the wall. In this embodiment, the nail head will have a rotatable operation to allow the user to twist the nail-like fasteners into place. In one embodiment, the edges of the nail head may have some sort of friction assistance for gripping, such as ridges.

In one embodiment, the nail-like fasteners are mounted through the backwall via a nail-like fastener housing (14) containing a spring load mechanism. In this embodiment, the nail-like fasteners do not protrude through the backwall until the user desires them to and pushes them (in a nail embodiment) or turns them (in a screw embodiment).

In one embodiment, the nail-like fasteners are replaceable. If one should become damaged, bent, blunted, stripped or otherwise unusable or unsuitable for the purpose described, because they are mounted through a mounting bracket housing, a user could remove the damaged nail-like fastener and replace with a brand new one. In addition, one could change from a nail-like fastener used as a nail to one used more like a screw, if desired.

In one embodiment, the nail-like fasteners are made of stainless steel to prevent rusting and promote reuse.

In one embodiment, when used as a rolling caddy, the castors provide sufficient height between the underside of the bottom most shelf and the surface of the floor, so that there is sufficient clearance for the entire device to roll without hitting and fasteners or clips that have already been put in place.

In one embodiment, the device is configured to provide two to three shelves of staggered depth for easy reaching, one or more of the shelves configured with mini bins to contain all components of popular leveling systems in an organized, easy-to-reach manner.

In one embodiment, the castors are configured to be mounted on a spring load system such that minimal force is required to lift the device free to begin rolling, and when that force removed, the device sets down on to legs that stabilize and immobilize the device into place.

In one embodiment, the device is configured to have an underside mount that can be set on any standard tripod allowing the device to be set into an infinite number of orientations and heights, limited only by the capability of the tripod.

### BRIEF DESCRIPTION OF THE DRAWINGS

FIG. 1 depicts one embodiment of the tiler caddy device as described, with a view from the front, showing a basic lower shelf (1), an upper shelf (2), the device also comprising castors (3), a center tripod mount (4), legs (5) with a bottom stabilizer (6).

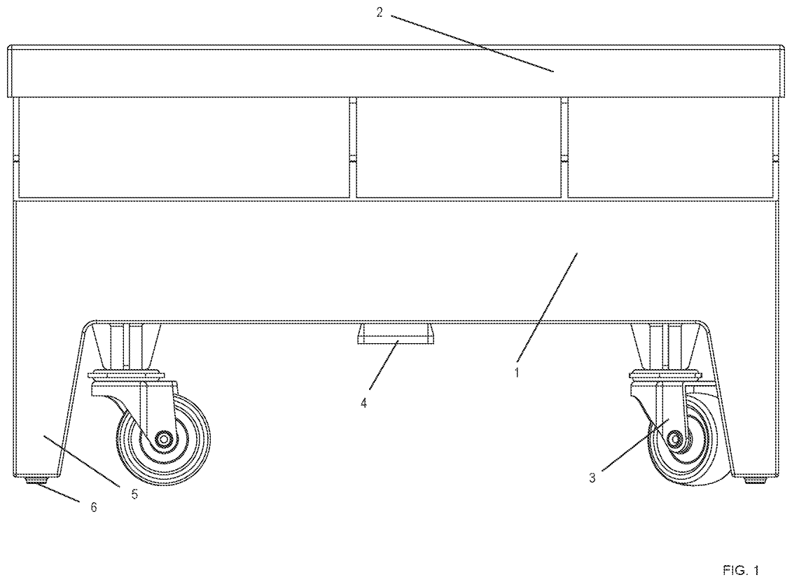

FIG. 2 depicts one embodiment of the tiler caddy device as described, with a view from one side, showing a basic lower shelf (1), an upper shelf (2) with a setback, the device also comprising castors (3), a center tripod mount (4), legs (5) with a bottom stabilizer (6).

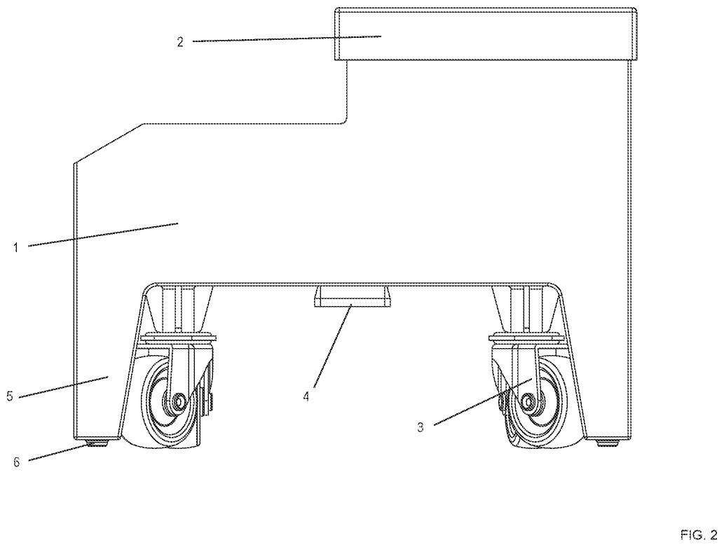

FIG. 3 depicts one embodiment of the tiler caddy device as described, with a view from the top, showing a basic lower shelf (1), an upper shelf (2), and one configuration of dividers (7).

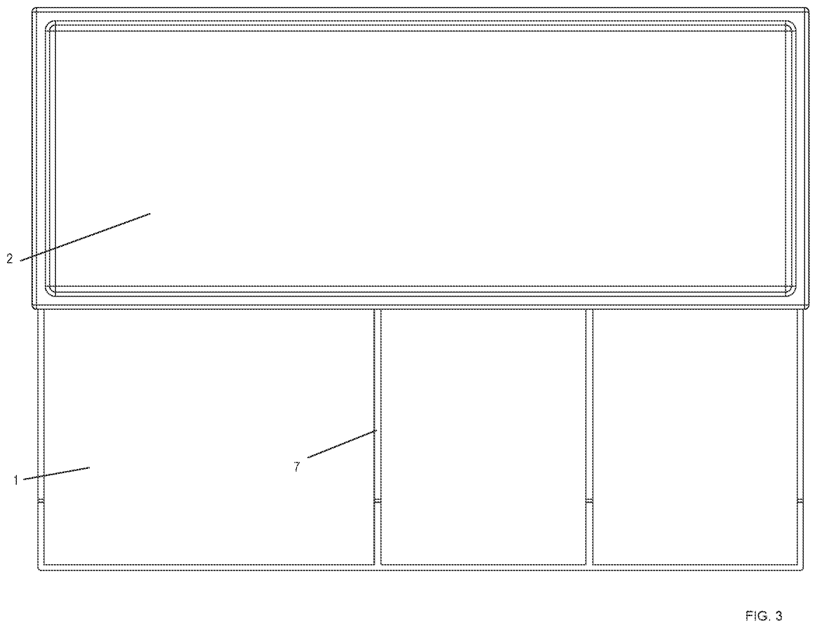

FIG. 4 depicts one embodiment of the tiler caddy device as described, with a perspective view, showing a basic lower shelf (1), an upper shelf (2) with a setback, the device also comprising castors (3), legs (5), and one configuration of dividers (7).

FIG. 5 depicts one embodiment of the tiler caddy device as described, with a view from the front showing the back wall (9), showing a basic lower shelf (1), an upper shelf (2), the device also comprising castors (3), a center tripod mount (4), legs (5) with a bottom stabilizer (6), and one configuration of a plurality of nail-like fasteners (8).

FIG. 6 depicts one embodiment of the tiler caddy device as described, with a view from one side showing the back wall (9), showing a basic lower shelf (1), an upper shelf (2), the device also comprising castors (3), a center tripod mount (4), legs (5) with a bottom stabilizer (6), and a plurality of nail-like fasteners (8).

FIG. 7 depicts one embodiment of the tiler caddy device as described, with a view from the top but showing the back wall (9), showing a basic lower shelf (1), an upper shelf (2), the device also comprising a plurality of nail-like fasteners (8), in this embodiment, showing only two top nail-like fasteners (others not shown, being hidden below the upper shelf (2)).

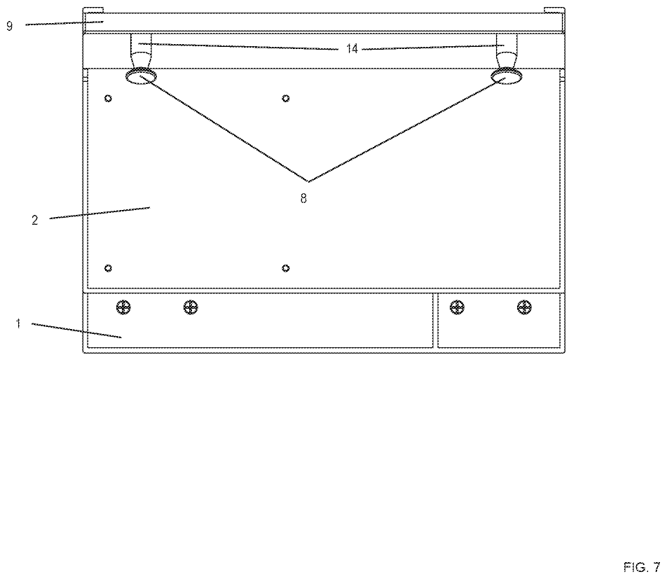

FIG. 8 depicts one embodiment of the tiler caddy device as described, with a perspective view showing the back wall (9), showing a basic lower shelf (1), an upper shelf (2), the device also comprising castors (3), a center tripod mount (4), legs (5) with a bottom stabilizer (6), and a plurality of nail-like fasteners (8), in this embodiment, showing only two top nail-like fasteners (others not shown, being hidden below the upper shelf (2)), and one configuration of dividers (7).

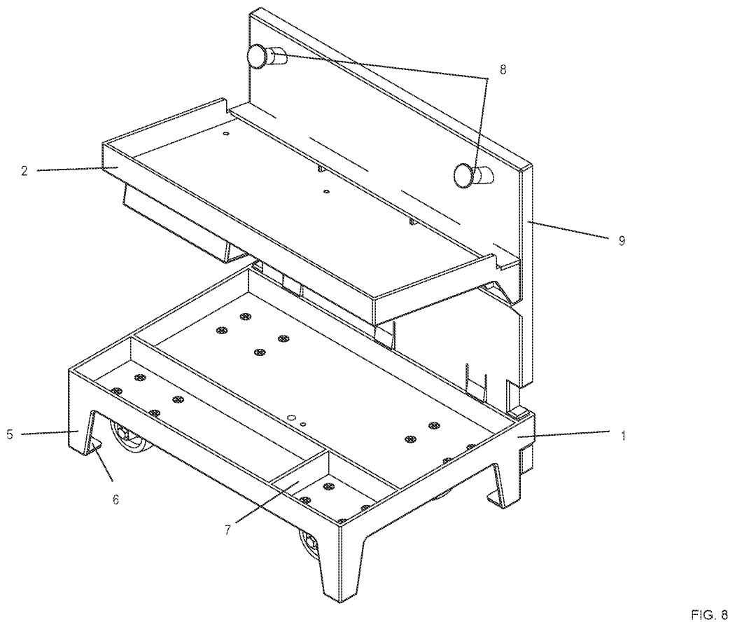

FIG. 9 depicts one embodiment of the tiler caddy device as described, with a view from underneath a second shelf looking down onto a basic lower shelf (1), showing a back wall (9), and, in this configuration, one of a plurality of nail-like fasteners (8) (others not shown, being hidden above the upper shelf), and one configuration of dividers (7).

FIG. 10 depicts one embodiment of the tiler caddy device as described, with a view from the front showing the back wall (9) and depicting an alternate arrangement on nail-like fasteners (8), in this configuration, two such nail-like fasteners generally orienting downward positioned along the top of the device, and three such nail-like fasteners generally orienting in various left and right directions vis a vis each other, below the upper shelf. Also shown in this view is one embodiment of laser levels (11) being mounted on the back wall of the device, one in a horizontal and one in a vertical mount.

FIG. 11 depicts two alternative embodiments of nail-like fasteners, one with smooth nail points (12) and the other with screw-like points (13) and further depicting that they can achieve various angles of penetration through the back wall.

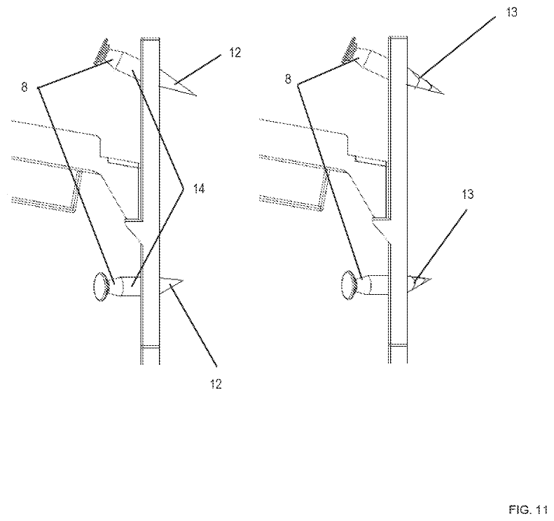

### DETAILED DESCRIPTION

For clarity of disclosure, and not by way of limitation, the detailed description of the invention is divided into the following subsections that describe or illustrate certain features, embodiments or applications of the present invention.

### Definitions

“basic lower shelf” as used herein means a main support platform the underside of which may contain legs, castors or other support means, the topside of which may contain bins, dividers, sidewalls, and/or other organizing means, and the topside further comprising support for one or more upper shelves and a back wall.

“upper shelf” as used herein means any additional support platform configured to be supported by the basic lower shelf which may contain bins, dividers, sidewalls, and/or other organizing means.

“castors” as used herein means rolling members attached to a fixed or rotatable support configured to support at least a portion of the underside of a basic lower shelf

“legs” as used herein means rigid members attached to a fixed support configured to support at least a portion of the underside of a basic lower shelf

“nail-like fastener” as used herein means any elongated shard or spike with a sharp end at one end and a surface at its opposite end that may be smooth or flat configured to allow a user to apply a force with a hammer or push or pull the object to insert the first sharp end in or out of a wall. As used herein, nail-like fastener also includes an elongated shard or spike with threads of any gauge, thickness or spacing to provide a screw like function and wherein the fastener can turn or rotate to enable such functionality.

“back wall” as used herein means a connecting surface that connects a basic lower shelf to any number of upper shelves, has an inner surface from which extend the basic lower shelf and the any number of upper shelves, and an outer surface, and may be configured to mount a plurality of nail-like fasteners for mounting the entire device to a surface wall, the sharp end of the nail-like fasteners extending from the outer surface and the smooth or flat end extending from the inner surface.

### The System and Method of the Present Invention

A typical tiler caddy device as described herein comprises a basic lower shelf supported by castors further comprising a spring mount, and further supported by a plurality of legs, further comprising a back wall, an at least one upper shelf, and a plurality of nail-like fasteners.

In one embodiment, the tiler caddy device may be constructed without legs and/or castors for use solely as a wall mounted device.

In one embodiment, the tiler caddy device may contain any number of shelf inserts or dividers to provide desired organizational compartments.

In one embodiment, the back wall may further comprise holes configured to contain hooks or other tool mounting capability means.

In one embodiment, a light may be configured to be mounted underneath one shelf.

In one embodiment, an electrical socket may be configured to be mounted on an outside wall, configured to received electrical current and in turn deliver that electrical current as desired.

In one embodiment, a drawer may be mounted to the back wall or underneath an upper shelf of the basic lower shelf.

In one embodiment, a center tripod mount may be constructed in the center of the underneath of the basic lower shelf configured to mount the entire device onto a tripod.

In one embodiment, the main components such as the shelves, sidewalls, backwall, etc, are all made from lightweight, durable hard plastic.

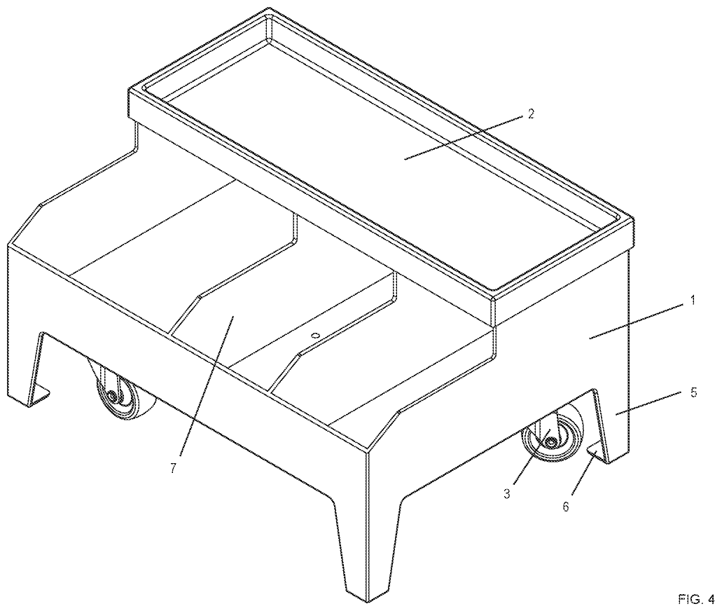

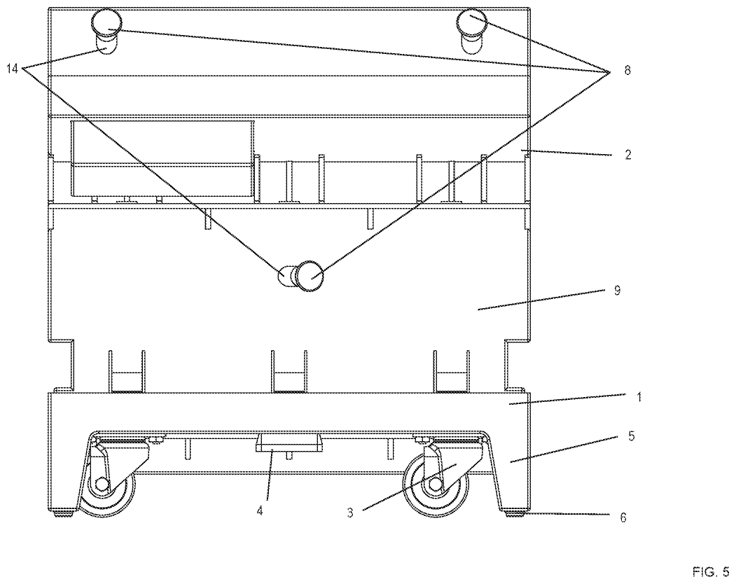

Referring to FIG. 4, in one embodiment, the device of the present disclosure appears to be a standard tool caddy, a system of shelves and compartments that can set next to a user to provide easy access to tools and supplies. It may contain shelves (2), compartments with dividers (7) for organization and it may sit firmly on a floor or other surface via its legs (5) and bottom supports (6), or it may wheel around via its wheels on castors (3). However, referring to FIG. 5, in one embodiment, the device of present disclosure may also be temporarily and securely attached to a wall in progress via nail-like fasteners (8) that are mounted through the back wall (9) in a manner such that they can function as described above.

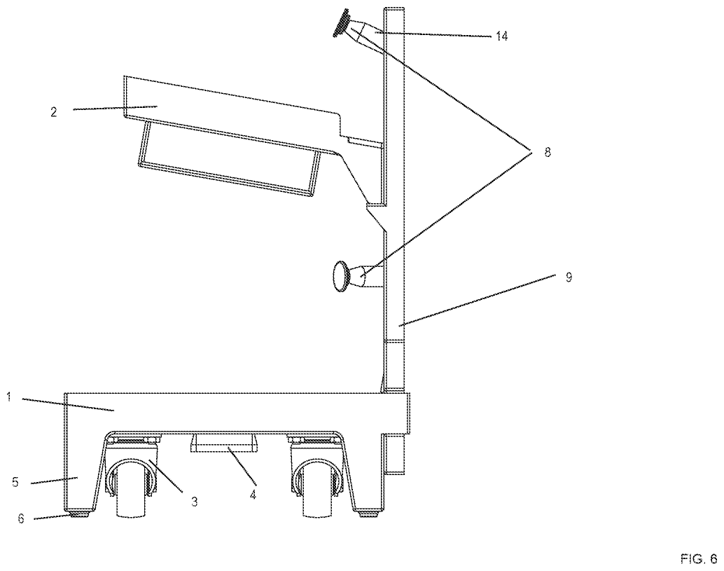

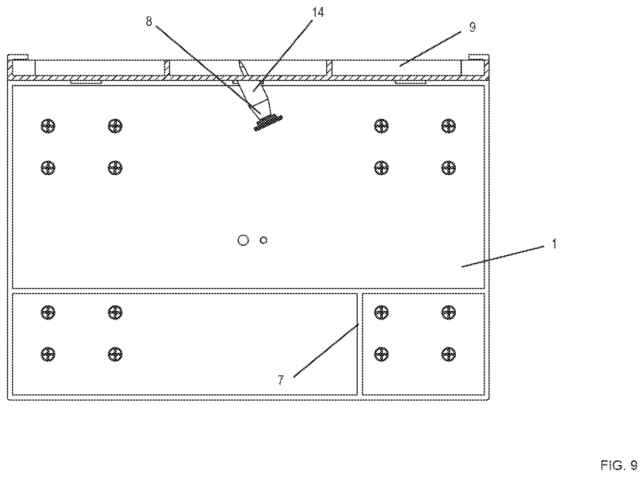

Referring to FIG. 6, in one embodiment, the top most nail-like fasteners orient in a generally downward direction such that they can support the device on a wall, gripping the wall somewhat like the nails of a picture hook. However, here, in one embodiment, there is a proprietary arrangement such that there may be two such fasteners at the top in a general downward direction for overall support, but at least one other such fastener at an underneath position and oriented in a left or right downward manner, that prevents any rotational torque and slippage of the device in its temporary location. This is also more clearly depicted in FIG. 9 where it is clear that the underneath nail-like fastener is oriented such that it penetrates more left. Nevertheless, the nail-like fasteners are moveable within a bracket mounting them through the backwall such that the user can manipulate the nail-like fasteners into any desired orientation when pushing them into the wall.

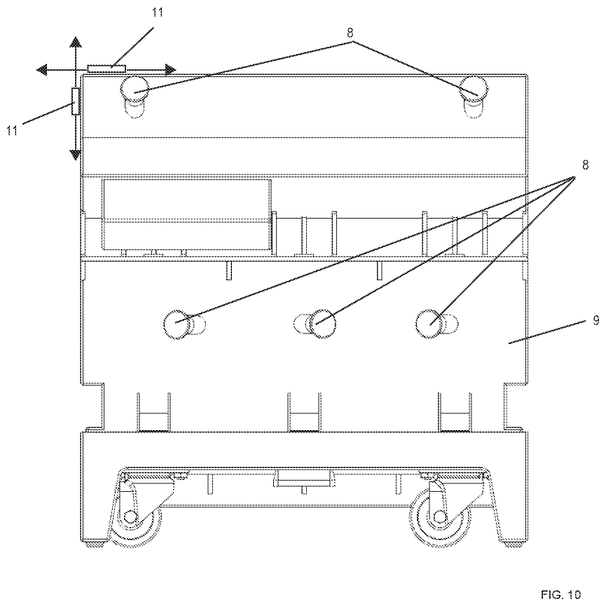

Referring to FIG. 10, in one embodiment, there could be a plurality of underneath nail-like fasteners (8), each moveable in its bracket mounting through the back wall (9) so that the user may orient the direction of any one of them to penetrate in any desired direction. Referring to FIG. 10, the nail-like fasteners (8) may have smooth, sharp, penetrating nail ends (12) that simply push into place, or the ends could contain threads and be more screw-like (13) such that they rotate into place much like a screw by turning (and come out by counter-rotation). In one embodiment, in the screw function embodiment, the turn could be anywhere from quarter turn through a couple full revolutions.

### EXAMPLES

The present invention is further illustrated, but not limited by, the following examples.

A typical use of a tiler caddy device as described herein is by a tile installer actively installing tile either on a floor or on a wall or both. In this example, the tile installer will require the tile to be installed, mastic for adhering the tile to the to be tiled surface, tools for spreading the tile mastic, tile spacers, and tools for insuring the tile is adhered level and level with respect to each other, as well as square and true. Such additional tools may require commercial leveling supplies as described above, a rubber mallet, a level, a pencil, a tile cutter, among other things. Additionally, the tile installer may want to have things such as a cell phone or other convenience items. To have all of these things at the ready, and capable of moving along with the tiler as they progress through the installation, the tile installer would first load all of the foregoing supplies into the various compartments of the tiler caddy device. Besides the tile itself and the mastic, the tile installer would then have every installation tool and convenience item in one organized place.

The tile installer would then roll the tile caddy device alongside themself as they progress along a floor installation and be able to directly move up a wall installation by then lifting the device and inserting the nail-like fasteners into an unfinished area of the wall. As progress is made, the device can be easily repositioned by simply lifting it off the wall and replacing the fasteners in a new unfinished area.

Thus, the tile caddy device as described herein will have all of the tile installer's supplies at the ready through any tile installation setting and can follow the tile installer through any installation and adapt to any installation setting along the way without any need to transfer supplies to separately adapted supply caddies.

The forgoing allows the tile installer to work fully hands-free, pocket-free, and pouch-free, with his or her tools and parts always within easy reach for greater comfort, efficiency and safety.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A device comprising:
a lower shelf comprising a lower shelf underside and a lower shelf topside, the lower shelf underside configured to have mounted at least one support means and the lower shelf topside having at least outer sidewalls configured to contain items, and attached to a backwall;
an at least one upper shelf comprising an upper shelf underside and an upper shelf topside, the upper shelf underside configured to mount onto and over the lower shelf topside, and the upper shelf topside having at least outer side walls configured to contain items, and attached to the same backwall at a position above the lower shelf;
a plurality of attached, supporting but moveable nail-like fasteners housed through the backwall via a housing bracket such that a sharp end is deployable to protrude approximately ½ past an outer outward facing surface of the backwall and an opposite smooth or flat ends protrude a pre-defined amount past an outer inward facing surface of the backwall, wherein at least one such nail-like fastener is positioned above the upper shelf topside and generally oriented downward, and at least one such nail-like fastener is positioned below the upper shelf underside and above the lower shelf topside but not directly vertically beneath at least one of the nail-like fasteners positioned above the upper shelf topside and further wherein said at least one such nail-like fastener is positioned below the upper shelf underside and above the lower shelf topside is orientable to a user choosable direction.

2. The device of claim 1, further comprising a plurality of castors.

3. The device of claim 2, wherein the castors are mounted with a spring attachment.

4. The device of claim 1, further comprising a plurality of legs.

5. The device of claim 1 wherein said one lower shelf and said at least one upper shelf are made from lightweight, durable, hard plastic.

6. The device of claim 1 wherein there are two nail-like fasteners positioned above the upper shelf topside and generally oriented downward.

7. The device of claim 6 wherein there is one nail-like fastener positioned below the upper shelf underside.

8. The device of claim 7 wherein all of the nail-like fasteners' housing brackets comprise a spring load mechanism such that until deployed, the nail-like fasteners are not protruding past the outer surface of the back wall at all.

9. The device of claim 7 wherein all of the nail-like fasteners contain sharp end threads to provide a screw like functionality.

10. The device of claim 1 wherein said device further comprises a first level mounted to a top portion of the backwall and a second level mounted to a side portion of the backwall.
